(19) United States
(12) Patent Application Publication
(10) Pub. No.: US 2026/0081273 A1
(43) Pub. Date: Mar. 19, 2026

(54) SECONDARY BATTERY AND METHOD FOR MANUFACTURING SAME

(71) Applicant: SAMSUNG SDI CO., LTD., Yongin-Si (KR)

(72) Inventors: Byunghuy CHO, Yongin-Si (KR); Junho BYEON, Yongin-Si (KR); Soyun KIM, Yongin-Si (KR); Hyojin LIM, Yongin-Si (KR)

(21) Appl. No.: 19/237,820

(22) Filed: Jun. 13, 2025

(30) Foreign Application Priority Data
Sep. 19, 2024 (KR) 10-2024-0126478

(51) Int. Cl. H01M 50/176; H01M 50/103; H01M 50/119; H01M 50/15; H01M 50/169

(52) U.S. Cl. CPC H01M 50/176; H01M 50/103; H01M 50/119; H01M 50/15; H01M 50/169

(57) ABSTRACT

A secondary battery includes: an electrode assembly including a positive electrode tab; and a case surrounding around the electrode assembly, and including: an accommodation portion accommodating the electrode assembly; a positive electrode terminal protruding from the accommodation portion in a first direction, and electrically connected to the positive electrode tab; and an upper flange extending from the accommodation portion in the first direction. A shortest length of the upper flange extending from the accommodation portion in the first direction is less than a length of the positive electrode terminal protruding from the accommodation portion in the first direction.

### CROSS-REFERENCE TO RELATED APPLICATION

The present application claims priority to and the benefit of Korean Patent Application No. 10-2024-0126478, filed on Sep. 19, 2024, in the Korean Intellectual Property Office, the entire disclosure of which is incorporated by reference herein.

### BACKGROUND

### 1. Field

Aspects of embodiments of the present disclosure relate to a secondary battery, and a method for manufacturing the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In secondary batteries, energy density may refer to the amount of energy that can be stored per unit volume. Secondary batteries with higher energy density may provide longer execution times or longer driving distances in portable devices or electric vehicles. Therefore, the energy density of secondary batteries may be one of the important factors that determine the performance of the secondary batteries.

The above information disclosed in this Background section is for enhancement of understanding of the background of the present disclosure, and therefore, it may contain information that does not constitute related (or prior) art.

### SUMMARY

Embodiments of the present disclosure may be directed to a secondary battery having high energy density, and a method for manufacturing the secondary battery.

These and other aspects and features of the present disclosure will be described in or will be apparent from the following description of embodiments of the present disclosure.

According to one or more embodiments of the present disclosure, a secondary battery includes: an electrode assembly including a positive electrode tab; and a case surrounding around the electrode assembly, and including: an accommodation portion accommodating the electrode assembly; a positive electrode terminal protruding from the accommodation portion in a first direction, and electrically connected to the positive electrode tab; and an upper flange extending from the accommodation portion in the first direction. A shortest length of the upper flange extending from the accommodation portion in the first direction is less than a length of the positive electrode terminal protruding from the accommodation portion in the first direction.

In an embodiment, the upper flange may include: a terminal region corresponding to the positive electrode terminal; and edge regions on opposite side surfaces of the terminal region. A length in the first direction of an edge region of the edge regions may be greater than a length of the terminal region in the first direction.

In an embodiment, the length of the edge region in the first direction may be greater than the length of the positive electrode terminal protruding from the accommodation portion in the first direction.

In an embodiment, a length of the terminal region in a second direction perpendicular to the first direction may correspond to a length of the electrode assembly in the second direction.

In an embodiment, a length of the terminal region in a second direction perpendicular to the first direction may correspond to a length of the positive electrode terminal in the second direction.

In an embodiment, the upper flange may include: a terminal region corresponding to the positive electrode terminal; and edge regions on opposite side surfaces of the terminal region. A length in the first direction of an edge region of the edge regions may be equal to a length of the terminal region in the first direction.

In an embodiment, the electrode assembly may further include a negative electrode tab. The case may further include a negative electrode terminal protruding from the accommodation portion in the first direction, and electrically connected to the negative electrode tab. The upper flange may include: a first terminal region corresponding to the positive electrode terminal; a second terminal region corresponding to the negative electrode terminal; a middle region between the first terminal region and the second terminal region; and edge regions on an outer side surface of the first terminal region and an outer side surface of the second terminal region, respectively. Lengths of the first terminal region and the second terminal region in the first direction may be less than lengths of the middle region and the edge regions in the first direction.

In an embodiment, the case may include: a main body having one opened side, and including the accommodation portion and the positive electrode terminal; and a cover joined to the one opened side of the main body.

In an embodiment, the cover may include a protrusion protruding in a third direction and joined to the main body.

In an embodiment, a length of the protrusion in the third direction may correspond to a thickness of the main body in the third direction.

In an embodiment, a length of the protrusion in the first direction may be 0.1 mm to 0.2 mm.

In an embodiment, corners of the protrusion may have a straight-angled shape or a curved shape.

In an embodiment, the case may further include: a lower flange extending from the accommodation portion in a direction opposite to that of the upper flange; and a side flange extending in a second direction perpendicular to the first direction.

In an embodiment, a thickness of the upper flange may be 0.1 mm.

In an embodiment, the case may include stainless steel (SUS).

According to one or more embodiments of the present disclosure, a method for manufacturing a secondary battery includes: preparing an electrode assembly including a positive electrode tab, and a main body including: an accommodation portion in which the electrode assembly is accommodated; and a positive electrode terminal protruding from the accommodation portion in a first direction, and electrically connected to a positive electrode tab; positioning the electrode assembly in the main body; forming a case by welding a cover to one opened side of the main body; and laser cutting a flange of the case. After the laser cutting, the case includes an upper flange extending from the accommodation portion in the first direction, and a shortest length of the upper flange extending from the accommodation portion in the first direction is less than a length of the positive electrode terminal protruding from the accommodation portion in the first direction.

In an embodiment, after the laser cutting, the case may include: a lower flange extending from the accommodation portion in a direction opposite to that of the upper flange; and a side flange extending in a second direction perpendicular to the first direction.

In an embodiment, the forming of the case may include joining the cover to the main body in a third direction, and the cover may include a protrusion protruding in the third direction and joined to the main body.

In an embodiment, the upper flange may include: a terminal region corresponding to the positive electrode terminal; and edge regions on opposite side surfaces of the terminal region. A length in the first direction of an edge region of the edge regions may be greater than a length of the terminal region in the first direction.

In an embodiment, the laser cutting may include laser cutting the edge regions except for the terminal region.

According to some embodiments of the present disclosure, a secondary battery having improved energy density, and a method for manufacturing the secondary battery, may be provided.

According to some embodiments of the present disclosure, the secondary battery in which a volume of a case may be reduced, and the method for manufacturing the secondary battery, may be provided.

According to some embodiments of the present disclosure, a welding quality of the secondary battery may be improved by increasing a fixing strength and a welding area in a case of the secondary battery.

According to some embodiments of the present disclosure, in a case of laser cutting the case of the secondary battery, damage to the electrode terminal due to the laser cutting may be prevented or substantially prevented by performing a cutting except for an electrode terminal region.

According to some embodiments of the present disclosure, by performing the cutting except for the electrode terminal region, a laser cutting process may be simplified, and costs of a secondary battery manufacturing process may be reduced.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an exploded perspective view of an example of a disassembled portion of a secondary battery according to an embodiment of the present disclosure;

FIG. 2 illustrates a plan view of an example of a case of a secondary battery after laser cutting according to an embodiment of the present disclosure;

FIG. 3 illustrates an enlarged plan view of the region A of FIG. 2;

FIG. 4 illustrates a flowchart of a method for manufacturing a secondary battery according to an embodiment of the present disclosure;

FIG. 5A illustrates a plan view of an example of a case of a secondary battery before laser cutting according to an embodiment of the present disclosure;

FIG. 5B illustrates a plan view of a laser cutting portion of a secondary battery according to an embodiment of the present disclosure;

FIG. 6A illustrates a plan view of an example of a case of a secondary battery before laser cutting according to an embodiment of the present disclosure;

FIG. 6B illustrates a plan view of a laser cutting portion of a secondary battery according to an embodiment of the present disclosure;

FIG. 6C illustrates a plan view of an example of a case of a secondary battery after laser cutting according to an embodiment of the present disclosure;

FIG. 7A illustrates a plan view of an example of a case of a secondary battery before laser cutting according to an embodiment of the present disclosure;

FIG. 7B illustrates a plan view of a laser cutting portion of a secondary battery according to an embodiment of the present disclosure;

FIG. 7C illustrates a plan view of an example of a case of a secondary battery after laser cutting according to an embodiment of the present disclosure;

FIG. 8A illustrates a plan view of an example of a case of a secondary battery before laser cutting according to an embodiment of the present disclosure;

FIG. 8B illustrates a plan view of a laser cutting portion of a secondary battery according to an embodiment of the present disclosure;

FIG. 8C illustrates a plan view of an example of a case of a secondary battery after laser cutting according to an embodiment of the present disclosure;

FIG. 9 illustrates a perspective view of an example of a protrusion of a cover before welding according to an embodiment of the present disclosure;

FIG. 10 illustrates a perspective view of an example of a protrusion of a cover before welding according to an embodiment of the present disclosure; and

FIG. 11 illustrates a perspective view of an example of a case of a secondary battery after welding according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section.

Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein.

Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. In other words, “and/or” includes any or all combinations of a plurality of items enumerated. When “C to D” is stated, it means C or more and D or less, unless otherwise specified.

In the present disclosure, the sizes and relative sizes of layers and regions shown in the drawings may be exaggerated for clarity of description. In other words, the sizes shown in the drawings are only for convenience of understanding and are not limited thereto. In addition, the same reference numerals denote the same elements throughout the specification.

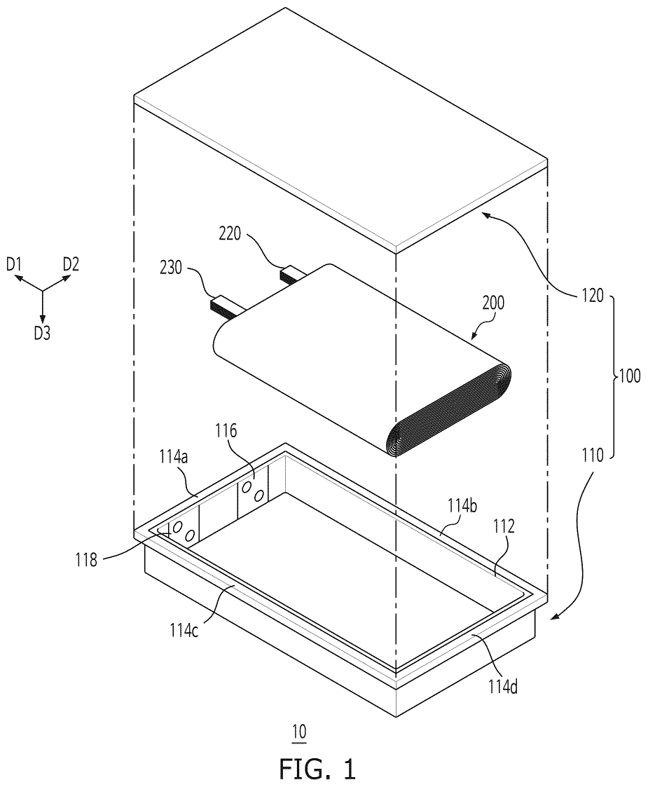

FIG. 1 illustrates an exploded perspective view of an example of a disassembled portion of a secondary battery according to an embodiment of the present disclosure.

Referring to FIG. 1, a secondary battery 10 may include an electrode assembly 200 including an electrode tab, and a case 100 in which the electrode assembly 200 is built or accommodated in. For example, the electrode assembly 200 may be wound or stacked with a separator, which is an insulator, provided between a positive electrode and a negative electrode. The secondary battery 10 illustrated in FIG. 1 may be an SUS can-type secondary battery, but the present disclosure is not limited thereto, and the secondary battery 10 may be various suitable kinds of secondary batteries.

Each of the positive electrode and the negative electrode may include a current collector including (e.g., made of) a thin metal foil having a coated portion on which an active material is coated and an uncoated portion on which the active material is not coated. The positive electrode and the negative electrode may be wound after interposing the separator, which is the insulator, therebetween. However, the present disclosure is not limited thereto, and the electrode assembly may have a structure in which a positive electrode and a negative electrode, each including (e.g., made of) a plurality of sheets, are alternately stacked with a separator interposed therebetween.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that can serve as a sacrificial positive electrode.

An amount of the positive electrode active material may be about 90 wt % to about 99.5 wt % based on 100 wt % of the positive electrode active material layer.

Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination thereof, but is not limited thereto.

The organic material and the inorganic material may be mixed in one coating layer, or a coating layer including an organic material and a coating layer including an inorganic material may be stacked.

The electrode assembly 200 may have a positive electrode tab 220 connected to one side of the positive electrode plate, and a negative electrode tab 230 connected to one side of the negative electrode plate. The positive electrode tab 220 and the negative electrode tab 230 may be connected by welding the tabs to the uncoated portions of the positive electrode plate and the negative electrode plate, or may be formed by punching out the uncoated portions of the positive electrode plate and the negative electrode plate. In a wound state, the positive electrode tab 220 and the negative electrode tab 230 may be positioned to be in parallel or substantially in parallel with each other with a suitable interval (e.g., a certain or predetermined interval) therebetween. In a case where the polarities of the positive electrode plate and the negative electrode plate are reversed, the positive electrode tab 220 may be formed as a negative electrode tab, and the negative electrode tab 230 may be formed as a positive electrode tab. In some embodiments, the electrode assembly 200 may have any suitable structure including the electrode tabs.

The case 100 may form the overall exterior of the secondary battery 10, and may include (e.g., may be made of) a conductive metal, such as aluminum, an aluminum alloy, or a nickel-plated steel. According to an embodiment, the case 100 may include a stainless material (e.g., SUS). In some embodiments, the case 100 may provide a space in which the electrode assembly is accommodated.

The case 100 according to an embodiment of the present disclosure may include a main body 110, and a cover 120 formed by separating a case membrane having an approximately rectangular shape from the main body 110.

An accommodation portion 112 for accommodating the electrode assembly 200 may be formed in an approximately central portion of the main body 110 by a press processing or the like. In some embodiments, flanges 114a, 114b, 114c, and 114d may be formed in four directions at upper edges of the accommodation portion 112.

According to an embodiment, the case 100 may be formed by joining the main body 110 and the cover 120 to each other. For example, the case 100 may be formed by metal-joining (e.g., welding, brazing, or soldering) the main body 110 and the cover 120 to each other. In the secondary battery 10, the case 100 and the flanges 114a, 114b, 114c, and 114d for joining may be formed. In some embodiments, the flanges 114a, 114b, 114c, and 114d may be cut using a laser.

A positive electrode terminal 116 electrically connected to the positive electrode tab 220 of the electrode assembly 200, and a negative electrode terminal 118 electrically connected to the negative electrode tab 230 of the electrode assembly 200, may be joined to the main body 110. For example, the positive and negative electrode terminals 116 and 118 may be provided on at least one surface of the case 100. The positions of the positive and negative electrode terminals 116 and 118 according to the present disclosure are not limited to the positions illustrated in FIG. 1, and may have various suitable modifications as needed or desired.

In an embodiment, the case 100 may include an electrolyte injection port. For example, the electrolyte injection port may be a through-hole formed on at least one surface of the case 100, and may be formed so that an electrolyte may be injected into the case 100 after the main body 110 and the cover 120 are bonded and sealed together. The electrolyte injection port may be sealed with a sealing member after the electrolyte is injected.

The secondary battery 10 may be a lithium battery cell, a sodium battery cell, or the like. However, the present disclosure is not limited thereto, and the secondary battery 10 may include any suitable kind of battery that is capable of repeatedly providing electricity through charging and discharging. In an embodiment, in a case where the secondary battery 10 is a lithium battery cell, the lithium battery cell may be used in electric vehicles (EVs), because the lithium battery cell may have excellent lifespan characteristics and high rate characteristics. For example, the lithium battery cell may be used in various suitable EVs, such as plug-in hybrid electric vehicles (PHEVs). In some embodiments, the lithium battery cell may be used in fields that require or desired a large amount of power storage. For example, the lithium battery cell may be used in electric bicycles, power tools, and the like.

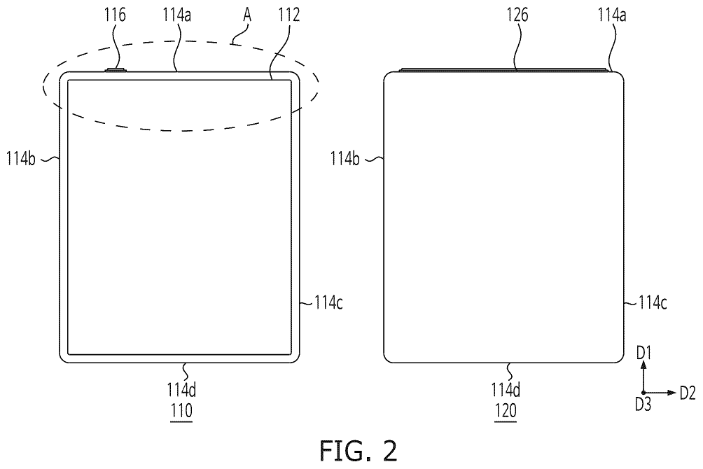

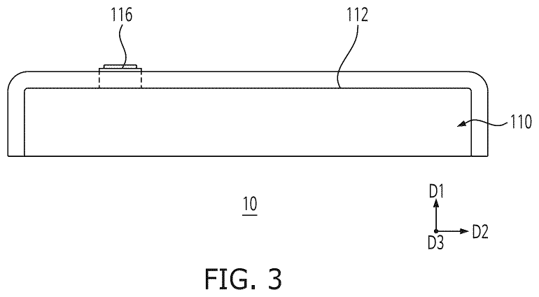

FIG. 2 illustrates a plan view of an example of a case of a secondary battery after laser cutting according to an embodiment of the present disclosure. FIG. 3 illustrates an enlarged plan view of the region A of FIG. 2. FIG. 2 illustrates a plan view of the main body 110 and cover 120 of the case 100 in a third direction (e.g., the D3 direction of the coordinate system of FIG. 1). The plan view shown in FIG. 2 shows lower surfaces of the main body 110 and the cover 120 of the case 100. FIG. 3 illustrates an enlarged view of the region A of the secondary battery 10 formed by joining the main body 110 and the cover 120 of FIG. 2 to each other.

Hereinafter, a first direction may be defined as the D1 direction of the coordinate system of FIG. 1, a second direction may be defined as the D2 direction of the coordinate system, and the third direction may be defined as the D3 direction of the coordinate system. In some embodiments, the D1, D2, and D3 directions may refer to (+) directions, and (−) directions may refer to directions opposite to the D1, D2, and D3 directions.

The case 100 may include the main body 110 having one opened side and including the accommodation portion 112 and the positive electrode terminal 116, and the cover 120 joined to one side of the main body 110. According to an embodiment of the present disclosure, the case 100 may include a metallic material, such as stainless steel (SUS) and/or aluminum (Al). However, the present disclosure is not limited thereto, and the case 100 may be composed of various suitable metallic materials that satisfy a desired strength and a desired resistance to external impacts for the secondary battery 10.

The cover 120 may include (e.g., may be composed of) a flat plate positioned on the upper surface of the main body 110 to seal the accommodation portion 112. For example, the cover 120 may be formed as a flat plate having a size sufficient to cover both the main body 110 and the flanges 114a, 114b, 114c, and 114d, and may come into surface contact with the flanges 114a, 114b, 114c, and 114d. In other words, the lower surface of the cover 120 and the upper surfaces of the flanges 114a, 114b, 114c, and 114d may be positioned to come into surface contact with each other.

The flanges 114a, 114b, 114c, and 114d may include (e.g., may be composed of) an upper flange 114a extending in the D1 direction from the accommodation portion 112 of the main body 110, side flanges 114b and 114c extending in the D2 direction from the accommodation portion 112 of the main body 110, and a lower flange 114d extending in a direction opposite to that of the upper flange 114a (e.g., in a direction opposite to the D1 direction) from the accommodation portion 112 of the main body.

The flanges 114a, 114b, 114c, and 114d may come into surface contact with the cover 120. By joining the flanges 114a, 114b, 114c, and 114d and the cover 120 to each other, the main body 110 and the cover 120 together may form a single joined structure. In an embodiment, the main body 110 may be bonded to the cover 120 by laser welding. However, the bonding method is not limited thereto, and various suitable bonding methods capable of sealing the case may be used. For example, the cover 120 and the flanges 114a, 114b, 114c, and 114d of the main body 110 may be joined to each other by ultrasonic welding, brazing, laser brazing, welding, or soldering, as well as, or instead of, the laser welding.

In an embodiment, the cover 120 may include (e.g., may be composed of) the same or substantially the same metallic material as that of the main body 110. Like the main body 110, the cover 120 may also include either stainless steel (SUS) or aluminum (Al).

According to some embodiments, the shortest length of the upper flange 114a extending from the accommodation portion 112 of the main body 110 in the D1 direction may be shorter than the length of the positive electrode terminal 116 protruding from the accommodation portion 112 in the D1 direction. In some embodiments, the lengths of the side flanges 114b and 114c and the lower flange 114d may be equal to or substantially equal to the shortest length of the upper flange 114a.

According to an embodiment, the length of the upper flange 114a extending from the accommodation portion 112 of the main body 110 in the D1 direction may be constant or substantially constant as the shortest length. In some embodiments, the length of the upper flange 114a extending from the accommodation portion 112 of the main body 110 in the D1 direction may be at least 0.2 mm. As described above, the case 100 according to some embodiments of the present disclosure includes the relatively short upper flange 114a, thereby reducing an external size of the secondary battery 10 and improving the energy density.

In some embodiments, the thickness of the upper flange 114a may be at least 0.1 mm. The thickness may refer to the length in the D3 direction. In some embodiments, the thicknesses of the side flanges 114b and 114c and the lower flange 114d may be equal to or substantially equal to the thickness of the upper flange 114a. In an embodiment, the thickness of the upper flange 114a may be 0.1 mm. A condition of the thickness (e.g., a thickness condition) may be related to improving the energy density of the secondary battery 10. In some embodiments, the thickness condition may be related to improving the quality of welding in a case of bonding the main body 110 and the cover 120 to each other.

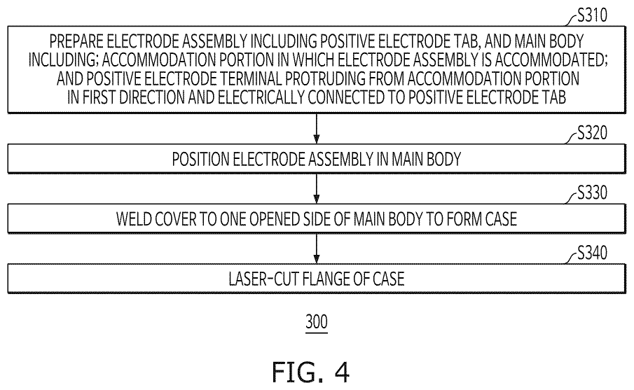

FIG. 4 illustrates a flowchart of a method for manufacturing a secondary battery according to an embodiment of the present disclosure.

Referring to FIG. 4, according to an embodiment, a method 300 for manufacturing a secondary battery may include preparing an electrode assembly including a positive electrode tab, and a main body including: an accommodation portion in which the electrode assembly is accommodated; and a positive electrode terminal protruding from the accommodation portion in a first direction (e.g., the D1 direction) and electrically connected to a positive electrode tab (S310).

The electrode assembly may be positioned in the main body (S320). Thereafter, a cover may be welded to one opened side of the main body to form a case (S330). Thereafter, a flange of the case may be laser-cut (S340).

The case after operation S340 may include an upper flange extending from the accommodation portion in the first direction (e.g., in the D1 direction), and the shortest length of the upper flange extending from the accommodation portion in the first direction (e.g., in the D1 direction) may be shorter than the length of the positive electrode terminal protruding from the accommodation portion in the first direction (e.g., in the D1 direction).

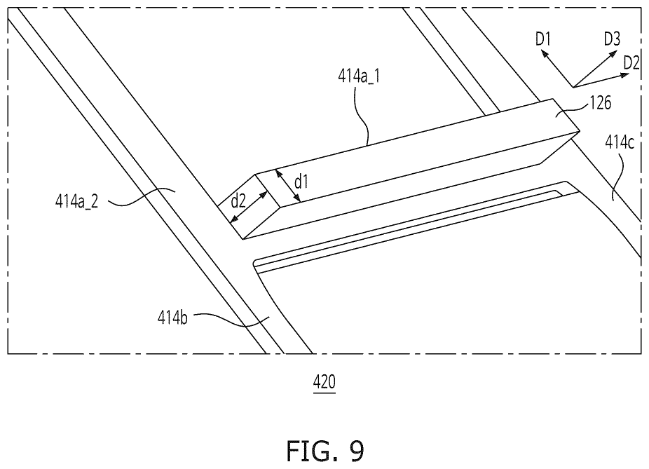

According to an embodiment, the operation of forming the case (S330) may include joining the cover to the main body in the third direction (e.g., the D3 direction), and the cover may include a protrusion protruding in the third direction (e.g., the D3 direction) to be assembled with the main body. This is described in more detail below with reference to FIGS. 9 to 11.

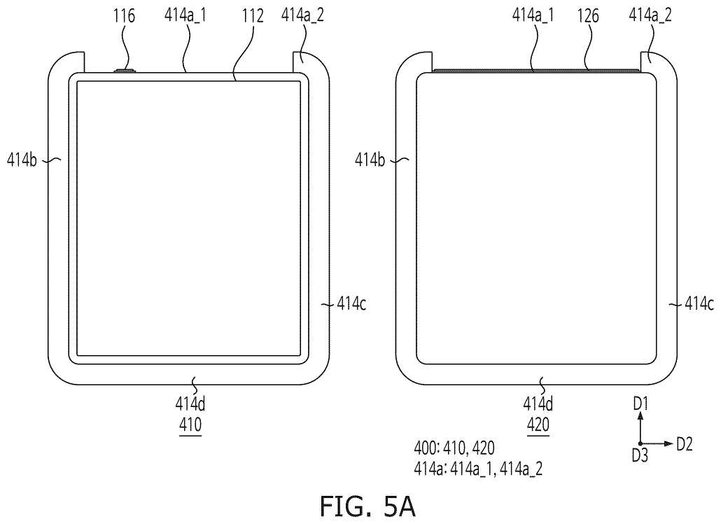

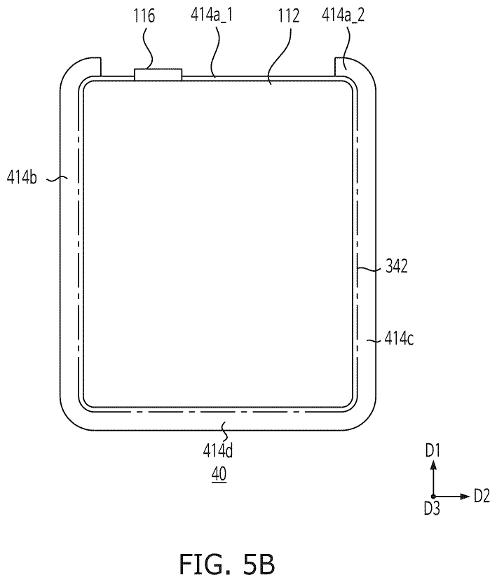

According to an embodiment, after the operation of forming the case (S330), the upper flange may include a terminal region corresponding to the positive electrode terminal, and edge regions positioned on opposite side surfaces of the terminal region. The length of the edge region in the first direction (e.g., the D1 direction) may be longer than the length of the terminal region in the first direction (e.g., the D1 direction). The upper flange refers to an upper flange before the laser cutting (S340). This is described in more detail below with reference to FIGS. 5A to 8A.

According to an embodiment, the laser cutting (S340) may include laser-cutting the edge region excluding the terminal region. In some embodiments, the case may further include a lower flange extending from the accommodation portion in a direction opposite to the first direction (e.g., in a direction opposite to the D1 direction), and a side flange extending in the second direction (e.g., the D2 direction) perpendicular to or substantially perpendicular to the first direction. The laser cutting may include cutting the lower flange and the side flange. The flanges 114a, 114b, 114c, and 114d (e.g., see FIG. 2) refer to the flanges after the laser cutting (S340), and flanges 414a, 414b, 414c, and 414d (e.g., see FIGS. 5A and 5B) refer to the flanges before the laser cutting. This is described in more detail below with reference to FIGS. 5A to 8C.

FIG. 5A illustrates a plan view of an example of the case of the secondary battery before the laser cutting according to an embodiment of the present disclosure. FIG. 5B illustrates a plan view of the laser cutting portion of the secondary battery according to an embodiment of the present disclosure.

As described above, the flanges 414a, 414b, 414c, and 414d refer to the flanges before the laser cutting. In some embodiments, a secondary battery 40, a main body 410, and a cover 420 refer to the secondary battery, the main body, and the cover before the laser cutting.

Referring to FIG. 5A, the case 400 may include the main body 410 having one opened side and including the accommodation portion 112 and the positive electrode terminal 116, and the cover 420 joined to one side of the main body. The flanges 414a, 414b, 414c, and 414d of the main body 410 and the cover 420 may include (e.g., may be composed of) an upper flange 414a extending in the D1 direction from the accommodation portion 112 of the main body 410, side flanges 414b and 414c extending in the D2 direction from the accommodation portion 112 of the main body 410, and a lower flange 414d extending in a direction opposite to that of the upper flange 414a (e.g., in a direction opposite to the D1 direction) from the accommodation portion 112 of the main body 410.

According to some embodiments, the upper flange 414a may include a terminal region 414a_1 corresponding to the positive electrode terminal 116, and an edge region 414a_2 positioned on opposite side surfaces of the terminal region. The length of the terminal region 414a_1 in the D1 direction may be less than the length of the positive electrode terminal 116 protruding from the accommodation portion 112 in the D1 direction. The length of the edge region 414a_2 in the D1 direction may be equal to or greater than the length of the terminal region 414a_1 in the D1 direction. In some embodiments, the length of the edge region 414a_2 in the D1 direction may be equal to or greater than the length of the positive electrode terminal 116 protruding from the accommodation portion 112 in the D1 direction.

According to an embodiment, the length of the terminal region 414a_1 in the D2 direction may correspond to the length of the electrode assembly 200 in the D2 direction. The length of the terminal region 414a_1 in the D2 direction may be less than the length of the electrode assembly 200 in the D2 direction. End portions of the edge region 414a_2 in the D2 direction and the direction opposite to the D2 direction may be formed to face each other. In some embodiments, the end portions of the edge region 412a_2 in in the D2 direction and the direction opposite to the D2 direction may be formed outside the end portions of the positive electrode terminal 116 in the D2 direction and the direction opposite to the D2 direction.

Referring to FIG. 5B, the secondary battery 40 may be formed by joining the cover 420 to the main body 410 to each other in the D3 direction. The secondary battery 40 may be formed by welding the cover 420 and the main body 410 to each other. As such, a welding line (not shown) may be formed on the flanges 414a, 414b, 414c, and 414d of the secondary battery 40.

According to some embodiments, the welding line may be positioned to surround (e.g., around a periphery of) the accommodation portion 112 (e.g., in a plan view) to block external moisture from being supplied to the electrode assembly 200 positioned in the accommodation portion 112. Accordingly, an operational stability of the electrode assembly 200 may be improved. In some embodiments, the welding line may be positioned to be sufficiently close to a sidewall of the main body 410 to sufficiently block moisture supply.

According to some embodiments, the flanges 414a, 414b, 414c, and 414d of the secondary battery 40 may be laser-cut. The secondary battery 40 may be laser-cut outside the welding line. The laser cutting may be performed on the lower surface of the main body 410 in the D3 direction.

According to an embodiment, the flanges 414a, 414b, 414c, and 414d of the secondary battery 40 may be laser-cut to the same or substantially the same length as each other. In some embodiments, the flanges 414a, 414b, 414c, and 414d of the secondary battery 40 may be laser-cut to the length of the terminal region 414a_1 of the upper flange 414a. Referring to FIG. 5B, the secondary battery 40 may be cut along a laser cutting line 342.

According to an embodiment, the side flanges 414b and 414c and the lower flange 414d may be laser-cut. In some embodiments, during the laser cutting, the edge region 414a_2 of the upper flange 414a may be laser-cut except for the terminal region 414a_1. In a case where the laser cutting is performed except for the terminal region 414a_1, damage to the positive electrode terminal 116 due to the laser cutting may be prevented or substantially prevented, and the laser cutting may be performed more simply and quickly.

In a case where the laser cutting is completed along the laser cutting line 342 for the secondary battery 40 shown in FIG. 5B, the secondary battery 10 shown in FIGS. 2 and 3 may be obtained. According to an embodiment, the flanges 114a, 114b, 114c, and 114d of the main body 110 and the cover 120 may have the same or substantially the same length as each other. In some embodiments, the secondary battery 10 may have the upper flange 114a, the length of which is less than the length of the positive electrode terminal 116 protruding from the accommodation portion 112 in the D1 direction. This characteristic configuration may improve the energy density in the secondary battery 10.

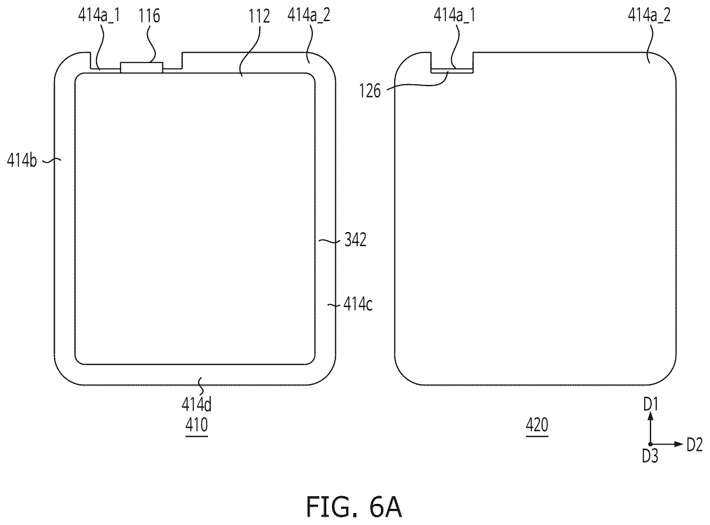

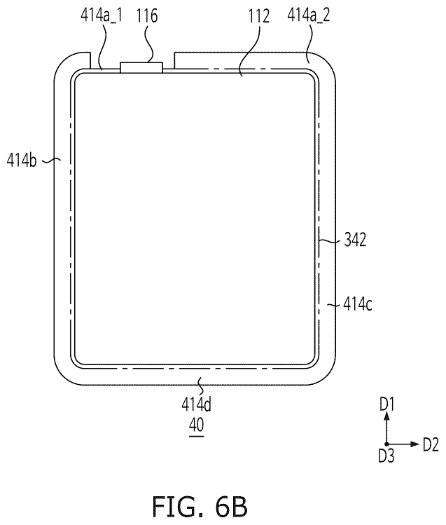

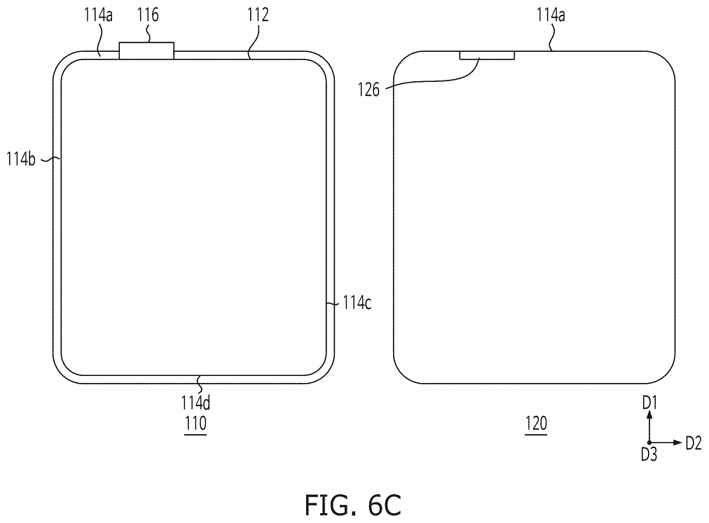

FIG. 6A illustrates a plan view of an example of the case of the secondary battery before the laser cutting according to an embodiment of the present disclosure. FIG. 6B illustrates a plan view of the laser cutting portion of the secondary battery according to an embodiment of the present disclosure. FIG. 6C illustrates a plan view of an example of the case of the secondary battery after the laser cutting according to an embodiment of the present disclosure. Hereinafter with reference to FIGS. 6A to 6C, the same or substantially the same configurations as those described above with reference to FIGS. 5A and 5B may not be repeated.

Referring to FIGS. 6A and 6B, the secondary battery 40 may be cut along the laser cutting line 342. FIG. 6C illustrates separate plan views showing the main body 110 of the case and the cover 120 after being cut along the laser cutting line 342 in the secondary battery 40 of FIG. 6B.

In the embodiments of FIGS. 6A to 6C, the length of the terminal region 414a_1 in the D2 direction before the laser cutting may be decreased, and the length of the edge region 414a_2 in the D2 direction may be increased, compared to the embodiments described above with reference to FIGS. 5A and 5B. As a result, in the embodiments of FIGS. 6A to 6C, the welding area of the upper flange 414a may be increased. Accordingly, the welding quality of the region of the upper flange 414a near the positive electrode terminal 116 may be improved, contributing to improving the safety of the secondary battery.

According to the embodiments of FIGS. 6A to 6C, the cover 420 may include a protrusion 126 protruding in the D3 direction. Referring to FIG. 6A, the upper flange 414a of the cover 420 may include the protrusion 126 protruding in the D3 direction and joined to the main body 410. The protrusion 126 may be formed by bending a portion of the cover 420 in the D3 direction, and may be formed by welding a metal to the lower surface of the upper flange 414a of the cover. By providing the protrusion 126, an accuracy of the joining position and/or the joining force between the cover 420 and the main body 410 may be increased.

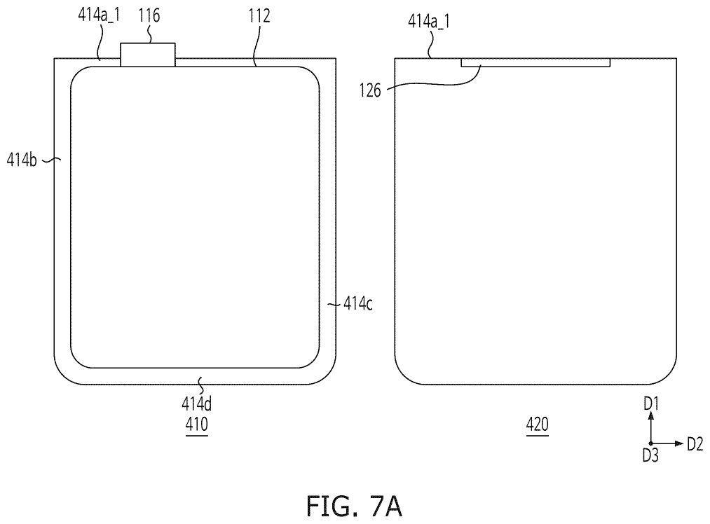

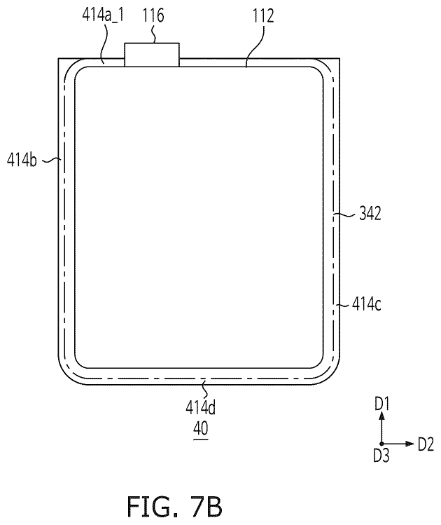

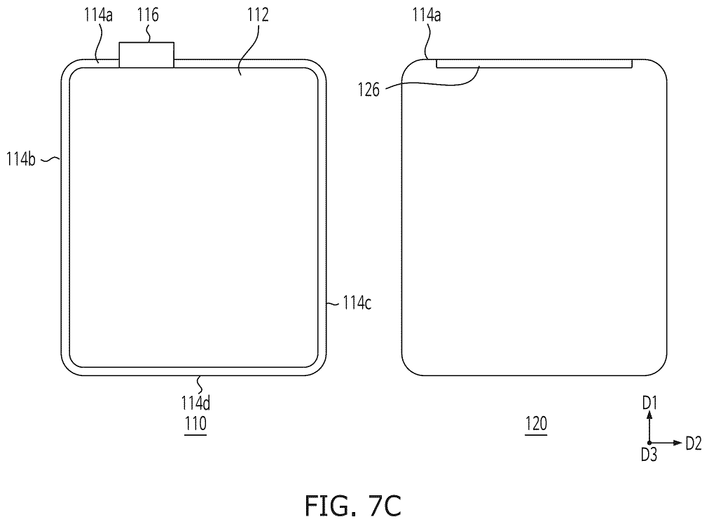

FIG. 7A illustrates a plan view of an example of a case of a secondary battery before laser cutting according to an embodiment of the present disclosure.

FIG. 7B illustrates a plan view of a laser cutting portion of a secondary battery according to an embodiment of the present disclosure. FIG. 7C illustrates a plan view of an example of a case of a secondary battery after laser cutting according to an embodiment of the present disclosure. Hereinafter with reference to FIGS. 7A to 7C, the same or substantially the same configurations as those described above with reference to FIGS. 5A to 6C may not be repeated.

According to an embodiment, the length of the edge region 414a_2 in the D1 direction may be equal to or substantially equal to the length of the terminal region 414a_1 in the D1 direction.

Referring to FIG. 7B, the secondary battery 40 may be cut along the laser cutting line 342. FIG. 7C illustrates separate plan views showing the main body 110 of the case and the cover 120 after being cut along the laser cutting line 342 in the secondary battery 40 of FIG. 7B.

In the embodiments of FIGS. 7A to 7C, the length of the edge region 414a_2 in the D1 direction before laser cutting may be reduced, compared to the embodiments described above with reference to FIGS. 5A to 6C. As a result, in the embodiments of FIGS. 7A to 7C, the laser cutting line 342 may be relatively reduced. Accordingly, because the configuration of the secondary battery is omitted, the laser cutting process may be more simplified, and costs of the secondary battery manufacturing process may be reduced.

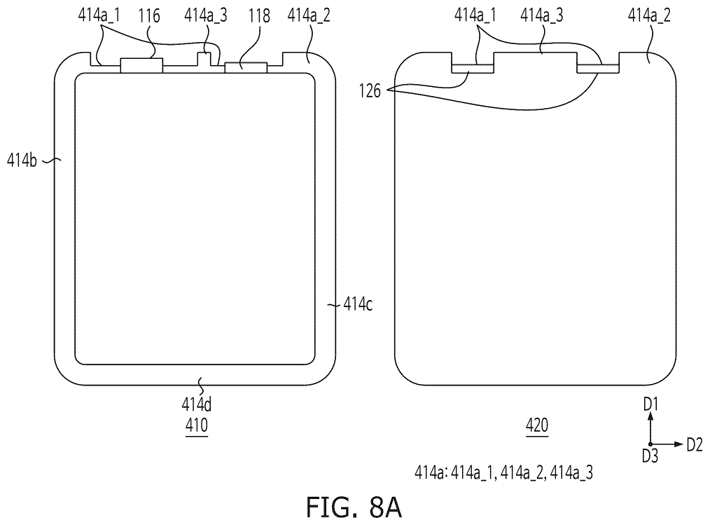

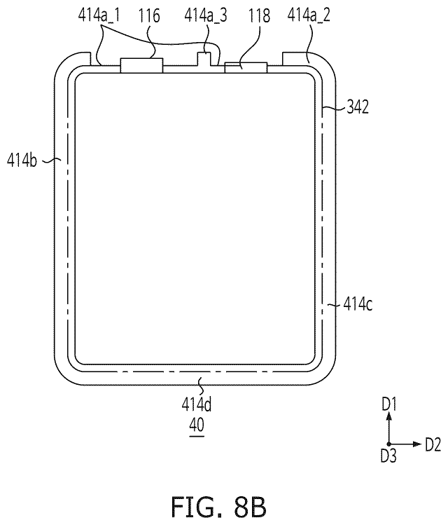

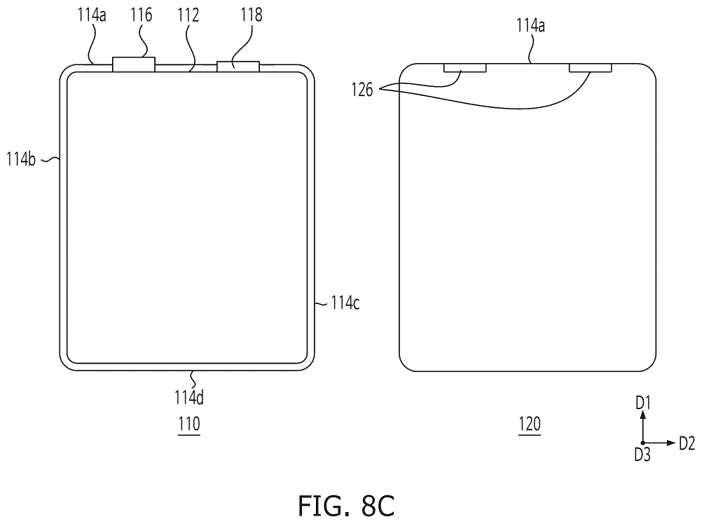

FIG. 8A illustrates a plan view of an example of a case of a secondary battery before laser cutting according to an embodiment of the present disclosure.

FIG. 8B illustrates a plan view of a laser cutting portion of a secondary battery according to an embodiment of the present disclosure. FIG. 8C illustrates a plan view of an example of a case of a secondary battery after laser cutting according to an embodiment of the present disclosure. Hereinafter with reference to FIGS. 8A to 8C, the same or substantially the same configurations as those described above with reference to FIGS. 5A to 7C may not be repeated.

In some embodiments, the electrode assembly 200 may further include a negative electrode tab 230. The main body 410 of the case 400 may further include a negative electrode terminal 118 that protrudes from the accommodation portion 112 in the D1 direction, and is electrically connected to the negative electrode tab 230.

According to some embodiments, the upper flange 414a may include a first terminal region 414a_1 corresponding to the positive electrode terminal 116, and a second terminal region 414a_1 corresponding to the negative electrode terminal 118. In some embodiments, the upper flange 414a may further include a middle region 414a_3 positioned between the first terminal region 414a_1 and the second terminal region 414a_1, and edge regions 414a_2 positioned on the outer side surface of the first terminal region 414a_1 and the outer side surface of the second terminal region 414a_1, respectively. The lengths of the first terminal region 414a_1 and the second terminal region 414a_1 in the D1 direction may be less than the length of the positive electrode terminal 116 protruding from the accommodation portion 112 in the D1 direction. The length of the edge region 414a_2 in the D1 direction may be equal to or greater than the length of the terminal region 414a_1 in the D1 direction.

According to an embodiment, the lengths of the first terminal region 414a_1 and the second terminal region 414a_1 in the D2 direction may correspond to the lengths of the positive electrode terminal 116 and the negative electrode terminal 118 in the D2 direction, respectively. The lengths of the first terminal region 414a_1 and the second terminal region 414a_1 in the D2 direction may be greater than the lengths of the positive electrode terminal 116 and the negative electrode terminal 118 in the D2 direction, respectively. The inner end portion of the edge region 414a_2 may be formed to face the end portions of the middle region 414a_3 in the D2 direction and the direction opposite to the D2 direction. In some embodiments, the end portions of the edge region 414a_2 and the middle region 414a_3 in the D2 direction and the direction opposite to the D2 direction may be formed outside the end portions of the positive electrode terminal 116 and the negative electrode terminal 118 in the D2 direction and the direction opposite to the D2 direction.

Referring to FIG. 8B, the secondary battery 40 may be cut along the laser cutting line 342. According to an embodiment, the side flanges 414b and 414c and the lower flange 414d may be laser-cut. In some embodiments, during laser cutting, the edge region 414a_2 and the middle region 414a_3 of the upper flange 414a excluding the first and second terminal regions 414a_1 may be laser-cut. FIG. 8C illustrates separate plan views showing the main body 110 of the case and the cover 120 after being cut along the laser cutting line 342 in the secondary battery 40 of FIG. 8B.

The embodiments of FIGS. 8A to 8C may further include a second terminal region 414a_1, compared to the embodiments of FIGS. 5A to 7C. As a result, in the embodiments of FIGS. 8A to 8C, laser cutting may be performed except for the second terminal region 414a_1. As such, it may be possible to improve the energy density of the secondary battery, while preventing or substantially preventing damage to the negative electrode terminal 118 due to the laser cutting.

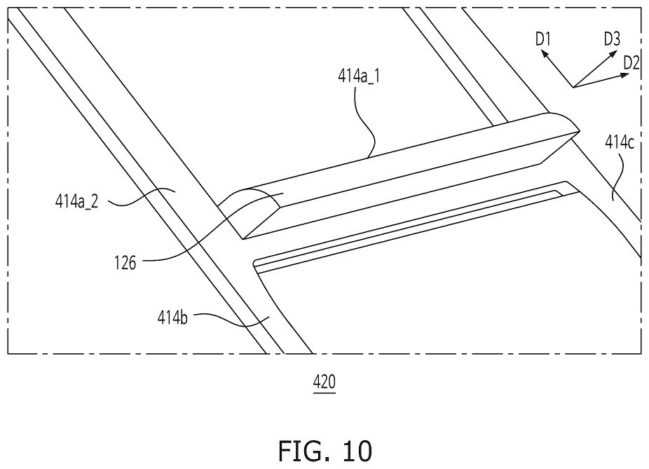

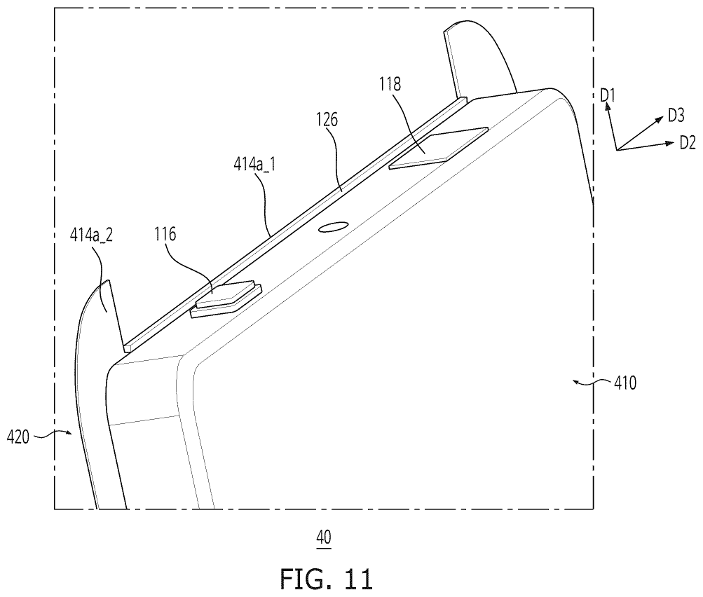

FIG. 9 illustrates a perspective view of an example of a protrusion of a cover before welding according to an embodiment of the present disclosure. FIG. 10 illustrates a perspective view of an example of a protrusion of a cover before welding according to an embodiment of the present disclosure. FIG. 11 illustrates a perspective view of an example of a case of a secondary battery after welding according to an embodiment of the present disclosure.

The flanges 414a, 414b, 414c, and 414d of the cover 420 according to some embodiments of the present disclosure may include an upper flange 414a extending in the D1 direction with respect to the accommodation portion 112, side flanges 414b and 414c extending in the D2 direction, and a lower flange 414d extending in the direction opposite to the D1 direction. The flanges 414a, 414b, 414c, and 414d of the cover 420 may correspond to the flanges 414a, 414b, 414c, and 414d of the main body.

According to some embodiments, the flanges 414a, 414b, 414c, and 414d of the cover 420 may include a protrusion 126 protruding in the D3 direction. Referring to FIG. 9, the upper flange 414a of the cover may include the protrusion 126 protruding in the D3 direction and joined to the main body 410. In some embodiments, the protrusion 126 may be formed on the side flanges 414b and 414c or the lower flange 414d of the cover 420. The protrusion 126 may be formed by bending a portion of the cover 420 in the D3 direction, and may be formed by welding a metal to the lower surfaces of the flanges 414a, 414b, 414c, and 414d of the cover.

According to some embodiments, the length of the protrusion 126 of the cover in the D2 direction may correspond to the length of the terminal region 414a_1 of the main body in the D2 direction. As such, the protrusion 126 may fix the main body 410 and the cover 420 in a case of being joined to each other.

According to some embodiments, a length d2 of the protrusion 126 in the D3 direction may correspond to the thickness of the main body in the D3 direction. However, in a case where the protrusion 126 is positioned on the upper flange 414a, a length d2 of the protrusion in the D3 direction may be formed so as not to come into contact with the positive electrode terminal 116. According to an embodiment, the length d2 of the protrusion 126 in the D3 direction may be at least 0.1 mm.

According to some embodiments, the length d1 of the protrusion 126 in the D1 direction may be the minimum thickness of the cover 420, and may be the minimum length of the upper flange 141a. According to an embodiment, the length d1 of the protrusion in the D1 direction may be 0.1 mm to 0.2 mm. As such, the length of the upper flange 141a may be minimized or reduced to improve the energy density, and the welding quality may be improved as the fixing strength and the welding area during welding may be increased.

In some embodiments, the corners of the protrusions 126 may be formed in a straight shape or a curved shape. For example, the protrusion 126 may have a pillar shape having a rectangular shape, a right triangular shape, or a fan shape in the cross-section cut in the D1 direction, and may have a pillar shape having a semicircle shape or a trapezoidal shape in the cross-section cut in the D2 direction. Referring to FIGS. 9 and 11, the shape of the protrusion 126 may be a rectangular pillar shape. With this characteristic configuration, the process of forming the protrusion 126 may be more simplified, and the protrusion 126 of the cover may come into surface contact with the upper end portion of the main body 410, thereby increasing the fixing strength and the welding area during welding and improving the welding quality.

In the embodiment of FIG. 10, compared to the embodiment of FIG. 9, in a case where the protrusion 126 has a fan-shaped pillar shape with curved corners, the region adjacent to the electrode terminal may be relatively thinner, and thus, may be more precisely sealed during welding. As such, the welding quality of the case 100 may be improved, and damage to the electrode terminal due to welding may be prevented or substantially prevented. However, the present disclosure is not limited thereto, and the shape of the protrusion is not limited to those of the embodiments illustrated in FIGS. 9 and 10.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

10: secondary battery
100: case
112: accommodation portion
116, 118: electrode terminal
110: main body
120: cover
126: protrusion
200: electrode assembly
220, 230: electrode tab
114a, 114b, 114c, 114d (414a, 414b, 414c, 414d): flange
342: laser cutting line

What is claimed is:

1. A secondary battery comprising:
an electrode assembly comprising a positive electrode tab; and
a case surrounding around the electrode assembly, and comprising:
an accommodation portion accommodating the electrode assembly;
a positive electrode terminal protruding from the accommodation portion in a first direction, and electrically connected to the positive electrode tab; and
an upper flange extending from the accommodation portion in the first direction,
wherein a shortest length of the upper flange extending from the accommodation portion in the first direction is less than a length of the positive electrode terminal protruding from the accommodation portion in the first direction.

2. The secondary battery as claimed in claim 1, wherein the upper flange comprises:
a terminal region corresponding to the positive electrode terminal; and
edge regions on opposite side surfaces of the terminal region,
wherein a length in the first direction of an edge region of the edge regions is greater than a length of the terminal region in the first direction.

3. The secondary battery as claimed in claim 2, wherein the length of the edge region in the first direction is greater than the length of the positive electrode terminal protruding from the accommodation portion in the first direction.

4. The secondary battery as claimed in claim 2, wherein a length of the terminal region in a second direction perpendicular to the first direction corresponds to a length of the electrode assembly in the second direction.

5. The secondary battery as claimed in claim 2, wherein a length of the terminal region in a second direction perpendicular to the first direction corresponds to a length of the positive electrode terminal in the second direction.

6. The secondary battery as claimed in claim 1, wherein the upper flange comprises:
a terminal region corresponding to the positive electrode terminal; and
edge regions on opposite side surfaces of the terminal region,
wherein a length in the first direction of an edge region of the edge regions is equal to a length of the terminal region in the first direction.

7. The secondary battery as claimed in claim 1, wherein the electrode assembly further comprises a negative electrode tab,
wherein the case further comprises a negative electrode terminal protruding from the accommodation portion in the first direction, and electrically connected to the negative electrode tab,
wherein the upper flange comprises:
a first terminal region corresponding to the positive electrode terminal;
a second terminal region corresponding to the negative electrode terminal;
a middle region between the first terminal region and the second terminal region; and
edge regions on an outer side surface of the first terminal region and an outer side surface of the second terminal region, respectively, and
wherein lengths of the first terminal region and the second terminal region in the first direction are less than lengths of the middle region and the edge regions in the first direction.

8. The secondary battery as claimed in claim 1, wherein the case comprises:
a main body having one opened side, and comprising the accommodation portion and the positive electrode terminal; and
a cover joined to the one opened side of the main body.

9. The secondary battery as claimed in claim 8, wherein the cover comprises a protrusion protruding in a third direction and joined to the main body.

10. The secondary battery as claimed in claim 9, wherein a length of the protrusion in the third direction corresponds to a thickness of the main body in the third direction.

11. The secondary battery as claimed in claim 9, wherein a length of the protrusion in the first direction is 0.1 mm to 0.2 mm.

12. The secondary battery as claimed in claim 9, wherein corners of the protrusion have a straight-angled shape or a curved shape.

13. The secondary battery as claimed in claim 1, wherein the case further comprises:
a lower flange extending from the accommodation portion in a direction opposite to that of the upper flange; and
a side flange extending in a second direction perpendicular to the first direction.

14. The secondary battery as claimed in claim 1, wherein a thickness of the upper flange is 0.1 mm.

15. The secondary battery as claimed in claim 1, wherein the case comprises stainless steel (SUS).

16. A method for manufacturing a secondary battery, the method comprising:
preparing an electrode assembly comprising a positive electrode tab, and a main body comprising:
an accommodation portion in which the electrode assembly is accommodated; and
a positive electrode terminal protruding from the accommodation portion in a first direction, and electrically connected to a positive electrode tab;
positioning the electrode assembly in the main body;
forming a case by welding a cover to one opened side of the main body; and
laser cutting a flange of the case,
wherein, after the laser cutting, the case comprises an upper flange extending from the accommodation portion in the first direction, and a shortest length of the upper flange extending from the accommodation portion in the first direction is less than a length of the positive electrode terminal protruding from the accommodation portion in the first direction.

17. The method as claimed in claim 16, wherein after the laser cutting, the case comprises:
a lower flange extending from the accommodation portion in a direction opposite to that of the upper flange; and
a side flange extending in a second direction perpendicular to the first direction.

18. The method as claimed in claim 16, wherein the forming of the case comprises joining the cover to the main body in a third direction,
wherein the cover comprises a protrusion protruding in the third direction and joined to the main body.

19. The method as claimed in claim 16, wherein the upper flange comprises:
a terminal region corresponding to the positive electrode terminal; and
edge regions on opposite side surfaces of the terminal region,
wherein a length in the first direction of an edge region of the edge regions is greater than a length of the terminal region in the first direction.

20. The method as claimed in claim 19, wherein the laser cutting comprises laser cutting the edge regions except for the terminal region.
